(19) United States
(12) Patent Application Publication
(10) Pub. No.: US 2005/0095083 A1
(43) Pub. Date: May 5, 2005

(54) Spiral coil shaped insertion body

(76) Inventor: Michio Masuda, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/679,421

(22) Filed: Oct. 7, 2003

(30) Foreign Application Priority Data
Oct. 8, 2002 (JP) 2002-328888

(51) Int. Cl. F16B 37/12

(52) U.S. Cl. 411/438

(57) ABSTRACT

A spiral coil shaped insertion body is composed of a cylinder portion having a fixed outside diameter and a taper portion having an outside diameter gradually reduced from the cylinder portion toward its distal end. The outside thread pitch diameter of the cylinder portion is greater than the pitch diameter of the female screw, and the inside thread pitch diameter of a region of the taper portion covering one or more turns is smaller than the pitch diameter of a male screw. The distal end of the taper portion may be extended directly to form a small-diameter cylinder portion.

### BACKGROUND OF THE INVENTION

1. Field of the Invention

The present invention relates to a spiral coil shaped insertion body used to reinforce a female screw of a flexible material.

2. Description of the Related Art

A spiral coil shaped insertion body (hereinafter referred to as insertion body) is set between a female screw and a male screw. Normally, the male screw is screwed into the insertion body after the insertion body is inserted into the female screw first. There is an insertion body that has a straight portion on its distal end, which facilitates a force of insertion to act on the insertion body to be inserted into the female screw (Japanese Examined Patent Document No. 28-4). Another example has a notch inside their distal end portion in place of the straight portion (U.S. Pat. No. 2,363,789 and Japanese Examined Utility Model Document No. 29-6109). In these cases, an insertion tool is hooked over the straight portion or notch to urge the insertion body to rotate as the insertion body is inserted into the female screw.

These conventional insertion bodies, however, have the following problems. (a) When the male screw is inserted into the insertion body that has the straight portion, the straight portion is a hindrance to the insertion. It is necessary, therefore, to break off the straight portion after the insertion and to notch the coil surface near the straight portion to facilitate the breakage of the straight portion. This entails high cost. Further, the broken piece must be removed from the threaded hole of the female screw, thus requiring troublesome operation. (b) On the other hand, the notched insertion body requires use of an insertion tool having a claw that can spring out and retract as the insertion body is inserted into the female screw. This tool is complicated in construction and expensive, however. In addition, the construction of the distal end portion of the insertion body, including the notch, to be caught by the insertion tool is intricate and costly. If the insertion body is small-sized, moreover, its notch is too small to be caught by the claw of the insertion tool with ease, so that the insertion is open to errors.

### SUMMARY OF THE INVENTION

The present invention has been contrived in consideration of these circumstances, and an object of the invention is to provide a spiral coil shaped insertion body that dispenses with a straight portion or notch. Another object of the invention is to provide a spiral coil shaped insertion body, capable of being securely inserted, having a simple construction, easy to manufacture, and low-priced.

In order to achieve at least one of the above objects, a spiral coil shaped insertion body according to the present invention is formed by coiling a wire having a rhombic cross section and is attached to a female screw of a flexible material, and comprises a cylinder portion having a fixed outside diameter and a taper portion having an outside diameter gradually reduced from the cylinder portion toward the distal end of the insertion body, wherein the outside thread pitch diameter of the cylinder portion is greater than the pitch diameter of the female screw, and the inside thread pitch diameter of a region of the taper portion covering one or more turns is smaller than the pitch diameter of a male screw.

The distal end of the taper portion may be extended to form a small-diameter cylinder portion for use as an insertion guide.

### BRIEF DESCRIPTION OF THE DRAWINGS

FIG. 1 is a side view of an insertion body according to one embodiment of the invention;

FIG. 2 is a sectional view of the insertion body according to the one embodiment;

FIG. 3 is a view illustrating the insertion body spirally fitted on a bolt;

FIG. 4 is a view illustrating the way the bolt fitted with the insertion body is screwed in a female screw;

FIG. 5 is a view illustrating the way the bolt is removed; and

FIG. 6 is a side view showing another embodiment.

### DESCRIPTION OF THE EMBODIMENTS

A first embodiment of the present invention will now be described first.

(a) General Configuration (FIG. 4)

After a spiral coil shaped insertion body (hereinafter referred to as insertion body) 1 is attached to a male screw 20 of a bolt 2 or the like by screwing, the bolt 2 is screwed into a female screw 50 of a structure 5 to clamp a clamped member 4. The insertion body 1 of the present invention obviates the use of a straight portion and a notch.

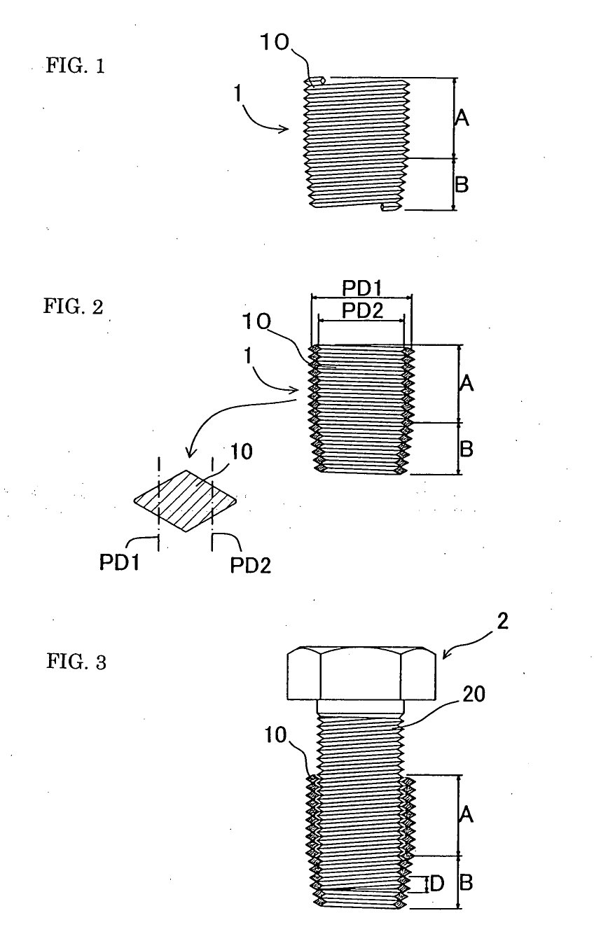

(b) Insertion Body (FIGS. 1 and 2)

The insertion body 1 is designed for a right-handed screw and is a spiral coil that resembles a right-handed screw. The insertion body 1 is formed by coiling a wire 10 that has a rhombic cross section. The shape and size of the rhombic wire 10 are adjusted to those of the threads of the male and female screw 20 and 50. In FIG. 2, PD1 and PD2 designate the outside and inside thread pitch diameters, respectively, of the insertion body 1. The insertion body 1 is composed of a cylinder portion A having a fixed outside diameter and a taper portion B having an outside diameter that gradually decreases from the cylinder portion A toward the distal end of the body 1. The outside and inside thread pitch diameters PD1 and PD2 of the cylinder portion A are fixed and greater than the respective pitch diameters of the female and male screws 50 and 20, respectively. The taper portion B is a bite portion, and its outside and inside thread pitch diameters PD1 and PD2 are gradually reduced. In a range that covers one or more turns at the extreme end portion, the inside thread pitch diameter PD2 is smaller than the pitch diameter of the male screw 20.

The following is a description of the way the insertion body 1 is attached to the female screw 50 of the structure 5 that is formed of a flexible material.

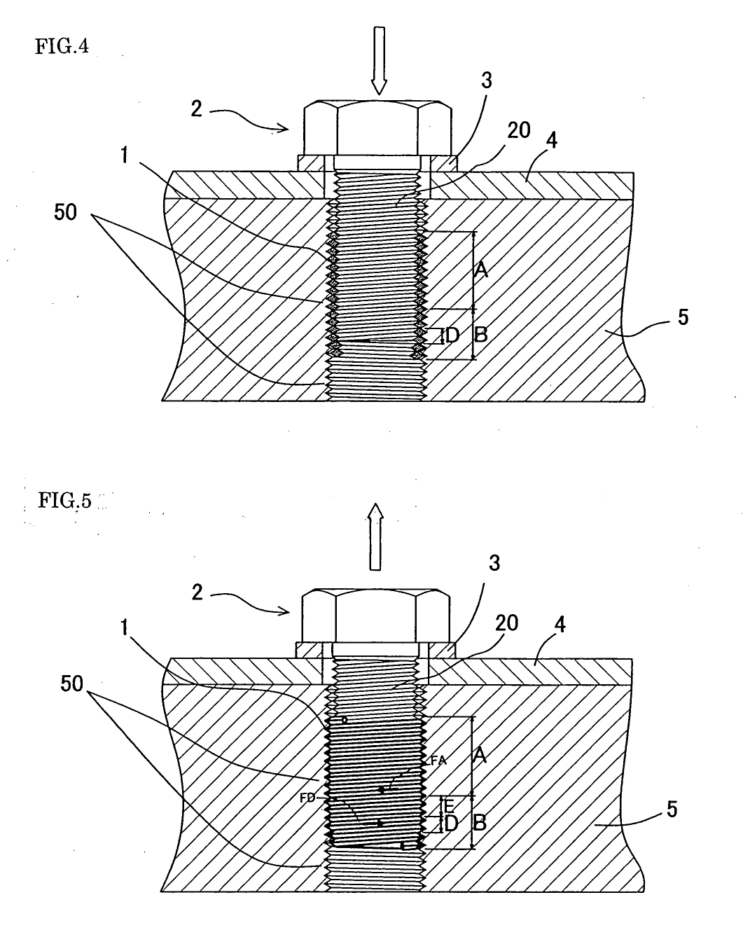

(c) Attachment to Bolt 2 (FIG. 3)

First, the insertion body 1 is attached to the bolt 2. In attaching the insertion body 1 to the bolt 2, the male screw 20 is inserted into the insertion body 1 through the cylinder portion A, and is rotated clockwise to be screwed into the taper portion B. Since the inside thread pitch diameter PD2 of the cylinder portion A is greater than the diameter of the male screw 20, the male screw 20 and the insertion body 1 easily mate with each other, and the distal end of the male screw 20 finally starts to be screwed into the taper portion B. As this is done, the insertion body 1 slides along the thread groove of the male screw 20. The inside thread pitch diameter PD2 of the taper portion B gradually decreases and is smaller than the pitch diameter of the male screw 20 in the range that covers one or more turns at the extreme end portion. When the spiral engagement in this region overreaches half a turn, the insertion body 1 is spread and diametrically extended. Thus, the insertion body 1 is closely wound onto the male screw 20 by its own elasticity, whereupon frictional force is produced. This frictional force suddenly increases as the length of the spiral engagement increases. Having a large diameter, the cylinder portion A never adheres to the male screw 20. A male screw contact portion D, a part of the taper portion B, is closely wound onto the male screw 20.

(d) Insertion into Female Screw 50 (FIG. 4)

The bolt 2 (see FIG. 3), thus fitted with the insertion body 1, is inserted into the female screw 50. Since the outside thread pitch diameter PD1 of the part that ranges from the distal end of the insertion body 1 to the male screw contact portion D is smaller than the pitch diameter of the female screw 50, there is a gap that allows the bolt 2 to be advanced with a very small turning effort. If the bolt 2 is rotated further, the middle part of the taper portion B, of which the outside thread pitch diameter PD1 increases gradually, touches the female screw 50. If the bolt 2 is rotated still further, the insertion body 1 is diametrically contracted and slides ahead along the thread groove of the female screw 50. In this manner, the insertion body 1 is screwed in together with the bolt 2. In this example, the bolt 2 is a hexagon head bolt, which fixes the clamped member 4 with the aid of a plain washer 3. FIG. 4 shows the bolt 2 that is tightened by being fully rotated. The insertion body 1 externally adheres to the female screw 50 and internally adheres to the male screw 20, thereby fixing them frictionally.

(e) Removal of Bolt 2 (FIG. 5)

In removing the bolt 2, it is rotated counterclockwise to be released from the fixed state. Before the rotation, the cylinder portion A of the insertion body 1 adheres to the female screw 50 by means of outward elasticity and is prevented from slipping by frictional force. When the male screw 20 rotates counterclockwise, a frictional force FA from the female screw 50 that acts on the cylinder portion A is right-handed, and a frictional force FD from the male screw 20 that acts on the male screw contact portion D is left-handed, that is, the forces FA and FD are opposite. Accordingly, a portion E of the wire 10 between the cylinder portion A and the male screw contact portion D starts to bulge outward to seek refuge. This bulge reaches the cylinder portion A, presses the cylinder portion A more heavily against the female screw 50, and increases the frictional force. The bulge of the portion E also reaches the male screw contact portion D and causes the contact portion D to bulge and leave the male screw 20, so that the frictional force is reduced. Thus, the male screw 20 starts to be disengaged from the insertion body 1 and slips out when it is further rotated counterclockwise, while the insertion body 1 remains as it is in the female screw 50. The bolt 2 can be mounted in the previous clamping position by being rotated clockwise again to be screwed into the insertion body 1.

The following is a description of a second embodiment of the present invention.

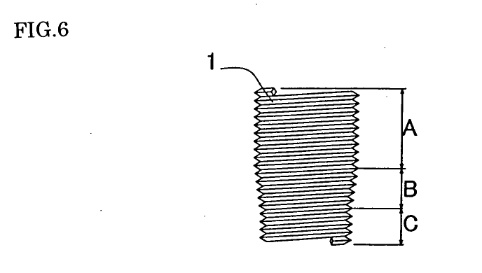

The distal end of a taper portion B; as a bite portion of an insertion body 1, may be extended to form a small-diameter cylinder portion C without changing its diameter (see FIG. 6). The small-diameter cylinder portion C serves as a guide for the insertion into a female screw 50 and is helpful to the improvement of the operating efficiency.

The present invention, arranged in this manner, can provide the following effects.

(a) The insertion body 1 is composed only of a cylinder portion or portions and a taper portion that adjoin one another, without including any straight portion or notch. Thus, the insertion body 1 has a simple construction, and it can be manufactured at low cost. Since it has neither a straight portion nor or a notch, moreover, it can be handled more easily than a conventional spiral coil shaped insertion body.

(b) Since the insertion body 1 can be kept fitted on a male screw when it is inserted into a female screw, the insertion requires no special tool. Further, there is no part to be broken off. These features are conducive to reduction in cost.

(c) Since the reasonable bite portion can be held when the insertion body 1 is smoothly inserted, distortion of pitches, which is usual with conventional products, can be avoided, and therefore, the product quality can be improved. This feature is particularly advantageous to small-sized products, so that the arrangement of the invention can be suitably applied to currently prevailing fine parts.

1. A spiral coil shaped insertion body which is formed by coiling a wire having a rhombic cross section and is attached to a female screw of a flexible material, the spiral coil shaped insertion body comprising:
a cylinder portion having a fixed outside diameter; and
a taper portion having an outside diameter gradually reduced from the cylinder portion toward the distal end of the insertion body,
the outside thread pitch diameter of the cylinder portion being greater than the pitch diameter of the female screw, and the inside thread pitch diameter of a region of the taper portion covering one or more turns being smaller than the pitch diameter of a male screw.

2. The spiral coil shaped insertion body according to claim 1, wherein the distal end of said taper portion is extended to form a small-diameter cylinder portion.
